(19) United States
(12) Patent Application Publication
(10) Pub. No.: US 2026/0169125 A1
(43) Pub. Date: Jun. 18, 2026

(54) APPARATUS FOR SYNCHRONIZING SENSOR DATA, SENSOR SYSTEM, AND METHOD FOR TESTING A SENSOR SYSTEM

(71) Applicant: Robert Bosch GmbH, Stuttgart (DE)

(72) Inventors: Kai Schulz, Balingen (DE); Tilman Gloekler, Reutlingen (DE)

(21) Appl. No.: 19/411,663

(22) Filed: Dec. 8, 2025

(30) Foreign Application Priority Data
Dec. 17, 2024 (DE) 10 2024 212 020.0

(51) Int. Cl. G01S 7/40

(52) U.S. Cl. CPC G01S 7/4021

(57) ABSTRACT

A synchronization of sensor data, as can be used, for example, for testing a downstream processing of the sensor data. Three operating modes are provided for this purpose. In one operating mode, real sensor data are received from an environment sensor and forwarded for subsequent processing according to the timing with which the sensor data are provided. In a further operating mode, previously stored sensor data are forwarded according to a timing with which the sensor data are provided. Furthermore, a third operating mode is provided in which previously stored sensor data are forwarded with a timing that corresponds to the timing of further data that are simultaneously provided by an environment sensor.

### FIELD

The present disclosure relates to an apparatus for synchronizing sensor data, and a sensor system comprising such an apparatus. The present disclosure further relates to a method for testing a sensor system.

### BACKGROUND INFORMATION

Radar systems play a central role in modern applications, in particular in the fields of driver assistance systems, autonomous mobility or industrial automation. Such systems make it possible to capture precise information about the surrounding area, including the position, speed, and direction of movement of objects. The reliability and accuracy of the data from such systems depend crucially on the efficiency and reliability of the signal evaluation.

Therefore, a significant aspect in the development of such radar systems or other systems for environment detection is the verification and validation of the evaluation logic. This requires efficient testing methods to verify the correct mode of operation of the signal evaluation under realistic conditions. In addition to tests under real-world conditions, further tests are also desirable, which are performed on the basis of simulated or previously stored scenarios. In particular, the aforementioned tests make it possible to carry out comparable tests during development, even after a modification of the evaluation logic.

For example, Germany Patent Application No. DE 10 2018 222 195 A1 describes a method for locating or classifying objects by means of a radar sensor. For this purpose, an evaluation system is proposed which uses an artificial neural network to evaluate the radar signals.

### SUMMARY

The present disclosure provides an apparatus for synchronizing sensor data, a sensor system, and a method for testing a sensor system. Advantageous embodiments are disclosed herein.

Accordingly, according to an example embodiment, the following is provided:
An apparatus for synchronizing sensor data, having a first input interface, a second input interface and a processing device. The first input interface is designed to receive sensor data from an environment sensor. The sensor data can be received, in particular, in the form of data packets. In particular, the data received by the first input interface can be provided by the environment sensor in real time. The second input interface is designed to receive previously stored sensor data. These previously stored sensor data can be received in the form of data packets by the second input interface. The processing device is designed to process sensor data from an environment sensor in at least three operating modes. In particular, in a first operating mode, the processing device is designed to read in and process the data packets from the environment sensor at the first input interface. In the first operating mode the data packets are accepted and processed with a timing that corresponds to the timing with which the data packets are provided by the environment sensor at the first input interface.

Furthermore, in a second operating mode, the processing device is designed to read in and process data packets from the second input interface. In the second operating mode the data packets are accepted and processed with a timing that corresponds to the timing with which the data packets are provided at the second input interface. Moreover, in a third operating mode, the processing device is designed to read in and process data packets from the second input interface, wherein, in the third operating mode, the data packets are accepted and processed with a timing that corresponds to the timing with which further data packets are provided by the environment sensor at the first input interface.

Furthermore, according to an example embodiment, the following is provided:
A sensor system having at least one environment sensor and an apparatus according to the present disclosure for synchronizing sensor data. The environment sensor is designed to provide sensor data in the form of data packets at the first input interface of the apparatus for synchronizing sensor data.

Finally, the following is provided according to an example embodiment:
A method for testing a sensor system, in particular a sensor system according to the present disclosure. The method comprises at least three operating modes. In the first operating mode, data packets are received from an environment sensor and forwarded. In the first operating mode, the data packets are accepted and forwarded with a timing that corresponds to the timing with which the data packets are provided by the environment sensor. In a second operating mode, previously stored data packets are received and forwarded. In the second operating mode, the data packets are received and forwarded with a timing that corresponds to the timing with which the previously stored data packets are provided. In a third operating mode, data packets are received and forwarded from previously stored data packets. In the third operating mode, data packets are received and forwarded with a timing that corresponds to the timing with which further data packets are provided by an environment sensor.

The present disclosure is based on the finding that, in addition to tests with real sensor data, the use of previously stored data can also be advantageous for testing an environment sensor, such as a radar sensor. Previously stored data offer the possibility to simulate specifically defined scenarios under controlled conditions and to test specific procedures of the evaluation logic. This is particularly helpful for tests that require repeatability or are intended to cover scenarios that are difficult to reproduce in real-world surrounding areas. For example, rare traffic events or complex multi-target detections can also be validated in this way.

However, a significant difference between real sensor data and stored data can lie in the timing of data provision. While real environment sensors typically provide data according to a timing sequence specified by the hardware, this timing can differ for stored data. However, for certain tests it may be desirable to process the stored data with a timing that corresponds to that of a real sensor. This makes it possible to carry out a realistic evaluation of the evaluation logic, since the temporal conditions of the real operational system are taken into account.

Based on this finding, it is therefore an idea of the present disclosure to be able to provide stored data in addition to real data for the testing of an evaluation logic, in particular an evaluation logic for processing sensor data for an environment sensor, and, if necessary, to synchronize the stored data to a timing of the real sensor.

In particular, the data for the evaluation logic can be provided in the form of data packets. The timing with which the stored data are forwarded to and processed by a downstream evaluation logic can be synchronized to packets as provided by a real sensor.

According to one example embodiment, the environment sensor comprises a radar sensor, an ultrasonic sensor and/or a LiDAR sensor. The environment sensor can be not only the pure sensor unit that only detects physical signals, but also a complete sensor system. In addition to sensor-based detection using microwave signals, ultrasound signals or laser signals, such a system can also comprise signal conditioning and, if necessary, analog-to-digital conversion (A/D conversion). By means of such integrated processing steps, the detected raw signal can be transformed into a form that can be directly used for the subsequent evaluation logic.

According to one example embodiment, the sensor data from the environment sensor and/or the previously stored sensor data are provided in an Advanced Microcontroller Bus Architecture (AMBA) protocol and are received in this form by the synchronization device. The AMBA protocol is a widely used standard to efficiently facilitate communication between various components of a System on a Chip (SoC). The AMBA protocol offers not only standardized data communication but also scalability and modularity, making it ideal for use in a wide variety of applications.

According to one example embodiment, the apparatus for processing the sensor data comprises a processing device. This processing device can be designed to receive and process the data provided by the synchronization device. The result of the processing can then be output by the processing device. The output of the result can also be done in the AMBA protocol if necessary.

According to one example embodiment, the apparatus for synchronizing sensor data is implemented as a System on a Chip (SoC). In particular, the apparatus can, if necessary, also be implemented as a monolithic microwave integrated circuit (MMIC) in combination with further components of an environment sensor, for example a radar sensor. This allows for a particularly compact design for processing and evaluating sensor data from an environment sensor. The concept according to the present disclosure enables reliable validation of the evaluation even in such a highly integrated circuit.

According to one example embodiment, the sensor system comprises a memory device. This memory device can be designed to store and provide sensor data for a test of the processing device. In particular, the sensor data can be stored and/or provided in the form of data packets.

According to one example embodiment, the stored sensor data can comprise simulated sensor data. Additionally or alternatively, the stored sensor data can also comprise previously captured sensor data from an environment sensor. By means of such stored sensor data, a data basis is thus available to reproducibly test and validate the sensor system.

The above example embodiments and developments can be combined with one another in any manner insofar as is reasonable. Further embodiments, developments, and implementations of this disclosure also include combinations, even those not explicitly mentioned, of features of the present disclosure described above or in the following with regard to the exemplary embodiments. A person skilled in the art will in particular also add individual aspects as improvements or additions to the respective basic forms of the example embodiments of the present disclosure.

### BRIEF DESCRIPTION

Further features and advantages of the present disclosure will be explained in the following with reference to the figures.

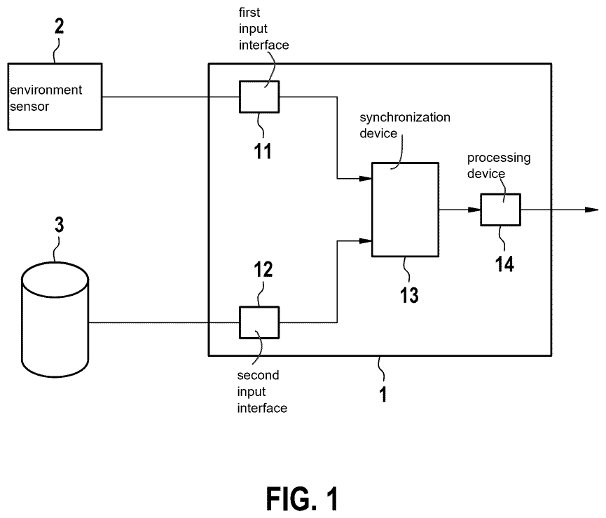

FIG. 1 is a schematic representation of a principle diagram of a sensor system in an apparatus for synchronizing sensor data according to one example embodiment.

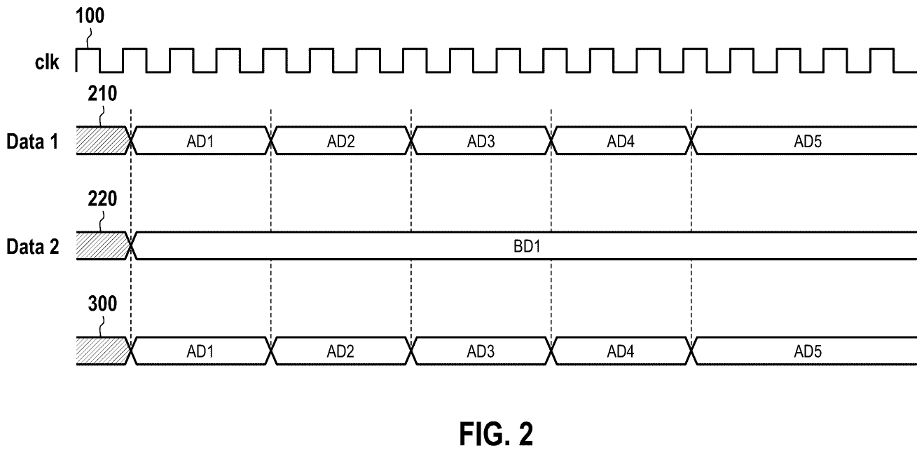

FIG. 2 is a timing diagram such as may underlie a first operating mode of an apparatus for synchronizing sensor data according to one example embodiment.

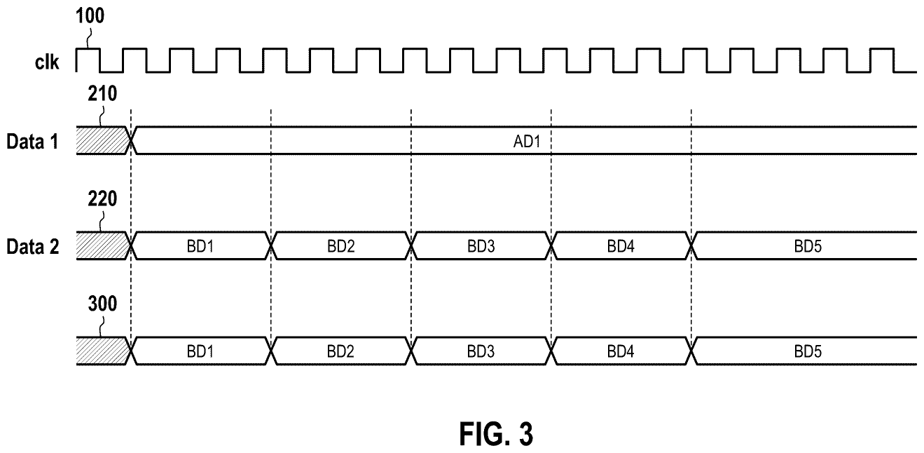

FIG. 3 is a timing diagram such as may underlie a second operating mode of an apparatus for synchronizing sensor data according to one example embodiment.

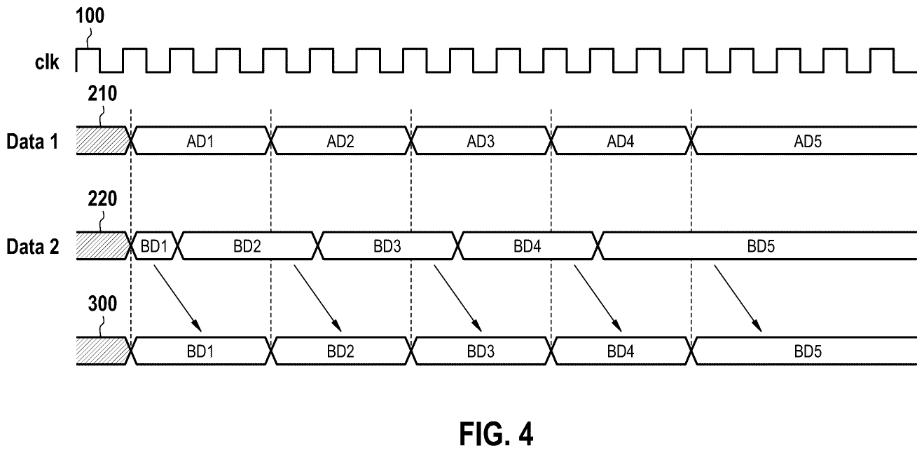

FIG. 4 is a timing diagram such as may underlie a third operating mode of an apparatus for synchronizing sensor data according to one example embodiment.

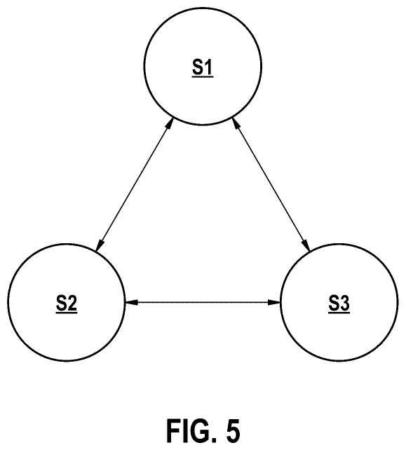

FIG. 5 is a flow chart such as may underlie a method for testing a sensor system according to one example embodiment.

### DETAILED DESCRIPTION OF EXAMPLE EMBODIMENTS

FIG. 1 is a schematic representation of a principle diagram of a sensor system having an apparatus 1 for processing sensor data according to one example embodiment. The apparatus 1 for processing the sensor data comprises a first input interface 11 and a second input interface 12. Furthermore, the apparatus 1 for synchronizing sensor data comprises a synchronization device 13 and a processing device 14.

Sensor data from an environment sensor 2 can be provided at the first input interface 11. The environment sensor 2 can be, for example, a radar sensor, an ultrasonic sensor or a LIDAR sensor. In particular, the environment sensor 2 can be not only a pure sensor unit that only detects physical signals, but also a complete sensor system that comprises not only the sensor-based detection of the surrounding area, but also signal conditioning and, if necessary, A/D conversion. By means of this integrated processing, the detected raw signals can be transformed into a form that can be used directly for subsequent evaluation. For example, the signals can be transmitted from the environment sensor 2 to the first input interface 11 on the basis of an Advanced Microcontroller Bus Architecture (AMBA) protocol. Optionally, both the environment sensor, or at least parts of the environment sensor, and the apparatus 1 for processing the sensor data can be implemented as a System on a Chip (SoC) and, if necessary, on a common chip.

At the second input interface 12, for example, sensor data from a further data source 3 can be provided. For example, the further data source 3 can provide previously stored sensor data. The previously stored sensor data can, for example, be real sensor data that were previously recorded using the environment sensor 2 or a comparable sensor system. Additionally or alternatively, simulated sensor data can also be provided by the further data source 3. The sensor data from the further data source 3 can, for example, also be provided in the same form as the sensor data from the environment sensor 2. In particular, the sensor data can also be provided in the AMBA protocol.

The data from the environment sensor 2 and the data from the further data source 3 can, for example, be provided in blocks or in the form of data packets. In principle, any type of data communication is possible, in particular in the form of packet-based data transmission. The timing of the data packets will be explained in more detail below.

The synchronization device 13 of the apparatus 1 for synchronizing sensor data can receive the sensor data from the first input interface or the second input interface and forward it to a downstream processing device 14 according to the principle explained in more detail below. For the processing of the sensor data by the downstream processing device 14, any type of data processing based on the sensor data provided by the environment sensor 2 or the further data source 3 is possible. The processing can comprise, for example, object detection, or the determination of the position, distance, speed or similar properties of an object. Furthermore, for example, object classification, clustering of individual targets or similar are also possible. Furthermore, if necessary, further control instructions for a downstream system can also already be derived by the processing device 14 on the basis of the sensor data. For example, driver assistance systems such as brake assistance, lane keeping assistance or similar systems can be controlled on the basis of the sensor data. Depending on the application, any other processing steps are also made possible by the processing device 14.

The result of the processing device 14 can then be output.

Three possible operating modes for the apparatus 1 for synchronizing sensor data are described below.

In a first operating mode, the apparatus 1 for synchronizing the sensor data carries out the data processing exclusively on the basis of the sensor data from the environment sensor 2. For this purpose, the sensor data from the environment sensor 2 are provided at the first input interface 11.

FIG. 2 is a timing diagram for forwarding sensor data in the first operating mode. In the top row clk, a clock signal 100 (Clock) is shown. On the basis of this clock signal 100, data transmission in the form of digital data can be carried out, for example via a bus system or similar. The clock signal 100 is to be understood only schematically. The number of clock pulses per data packet does not represent a limitation of the present disclosure.

In the row below (Data 1), the data signal 210 of the sensor data from the environment sensor 2 is shown. As can be seen here, the environment sensor 2 provides the sensor data in a sequence of data packets ADn.

The further data source 3 does not provide any relevant data (Data 2) in this first operating mode. Accordingly, the data are forwarded from the first input interface 11 to the synchronization device 13. The timing of the forwarded data 300 corresponds to the timing of the data packets 210 from the environment sensor 2.

FIG. 3 is a schematic representation of a timing diagram for a second operating mode of the apparatus 1 for synchronizing sensor data. In this second operating mode, pre-stored data from the further data source 3 are provided at the second input interface 12. The corresponding data signal (Data 2) is shown as signal 220 in FIG. 3. Here as well, the data 220 are provided by the further data source 3 in the form of data packets BDn. In this second operating mode, the environment sensor 2 either does not provide any sensor data, or the sensor data 210 provided by the environment sensor 2 is ignored. Thus, the data packets 220 provided by the further data source 3 are provided as data packet 300 (Data 3) to the processing device 14 according to the timing of the further data source 3.

Moreover, a further, third operating mode is provided in the apparatus 1 for synchronizing sensor data, as shown in FIG. 4. Data 220 are provided from the further data source 3 in the form of data packets BDn. At the same time, data packets 210 are also provided by the environment sensor 2. In this third operating mode, the data packets from the further data source 3, which are provided at the second input interface 12, are forwarded to the processing device 14 according to a timing that corresponds to the timing of the data packets 210 from the environment sensor 2 at the first input interface 11. In other words, in each case, a data packet from the further data source 3 is forwarded to the processing device 14 if a data packet from the environment sensor 2 is received at the first input interface 11. In this way, the data packets from the further data source 3 can be forwarded to the processing device 14 according to the packet rate from the environment sensor 2.

FIG. 5 is a flow chart that may underlie a method for testing a sensor system according to one embodiment. The method can, in principle, comprise any steps, as have been described above in connection with apparatus 1 for synchronizing sensor data in a sensor system. Analogously, the previously described apparatus 1 for synchronizing sensor data, or the sensor system having such an apparatus 1, can also comprise any components that are suitable for Implementing the method described below.

In a first operating mode S1, data packets are received from an environment sensor 2 and forwarded, wherein in the first operating mode the data packets are accepted and forwarded with a timing that corresponds to the timing with which the data packets are provided by the environment sensor 2.

In a second operating mode S2, previously stored data packets, for example from a data source 3, are received and forwarded, wherein in the second operating mode the data packets are received and forwarded with a timing that corresponds to the timing with which the previously stored data packets are provided by the further data source 3.

Finally, in a third operating mode S3, previously stored data packets are received and forwarded, wherein in this third operating mode the data packets are received and forwarded with a timing that corresponds to a timing with which further data packets are simultaneously provided by an environment sensor.

The method can also comprise a step in which data from an environment sensor are pre-stored. The data from the environment sensor can either come from the environment sensor that also provides the data in the first operating mode. Alternatively, the data can also be provided by an identical or similar environment sensor. Furthermore, it is also possible to record and store data that were generated on the basis of simulations for such an environment sensor.

In summary, the present disclosure relates to a synchronization of sensor data, as can be used, for example, for testing a downstream processing of the sensor data. Three operating modes are provided for this purpose. In one operating mode, real sensor data are received from an environment sensor and forwarded for subsequent processing according to the timing with which the sensor data are provided. In a further operating mode, previously stored sensor data are forwarded according to a timing with which the sensor data are provided. Furthermore, a third operating mode is provided in which previously stored sensor data are forwarded with a timing that corresponds to the timing of further data that are simultaneously provided by an environment sensor.

1-10. (canceled)

11. An apparatus for synchronizing sensor data, comprising:
a first input interface configured to receive sensor data from an environment sensor in a form of data packets, wherein the data packets received by the first input interface are provided by the environment sensor in real time;
a second input interface configured to receive previously stored sensor data in the form of data packets; and
a synchronization device configured:
in a first operating mode, to read in the data packets from the environment sensor at the first input interface and forward the read in data packets from the environment sensor to a downstream processing device, wherein, in the first operating mode, the synchronization device is configured to forward the read in data packets from the environment sensor with a timing that corresponds to a timing with which the read in read in data packets from the environment sensor are provided by the environment sensor at the first input interface,
in a second operating mode, the synchronization device is configured to read in data packets from the second input interface and forward the read in data packets from the second input interface to the downstream processing device, wherein, in the second operating mode, the synchronization device is configured to forward the read in data packets from the second input interface with a timing that corresponds to a timing with which the read in data packets from the second interface are provided at the second input interface, and
in a third operating mode, to read in the data packets from the second input interface and forward the read in data packets from the second input interface to the downstream processing device, wherein, in the third operating mode, synchronization device is configured to forward the read in data packets from the second input interface with a timing that corresponds to a timing with which further data packets are provided by the environment sensor at the first input interface.

12. The apparatus according to claim 11, wherein the environment sensor includes a radar sensor and/or an ultrasonic sensor and/or a LiDAR sensor.

13. The apparatus according to claim 11, wherein the sensor data from the environment sensor and/or the previously stored sensor data are received in an Advanced Microcontroller Bus Architecture (AMBA) protocol.

14. The apparatus according to claim 11, further comprising:
a processing device configured to process the data packets provided by the synchronization device and to output a result of the processing.

15. The apparatus according to claim 11, wherein the apparatus is implemented as a System on a Chip (SoC) or a monolithic microwave integrated circuit (MMIC).

16. A sensor system, comprising:
at least one environment sensor; and
an apparatus for synchronizing sensor data, including:
a first input interface configured to receive sensor data from the at least one environment sensor in a form of data packets, wherein the data packets received by the first input interface are provided by the environment sensor in real time,
a second input interface configured to receive previously stored sensor data in the form of data packets, and
a synchronization device configured:
in a first operating mode, to read in the data packets from the environment sensor at the first input interface and forward the read in data packets from the at least one environment sensor to a downstream processing device, wherein, in the first operating mode, the synchronization device is configured to forward the read in data packets from the at least one environment sensor with a timing that corresponds to a timing with which the read in read in data packets from the environment sensor are provided by the at least one environment sensor at the first input interface,
in a second operating mode, the synchronization device is configured to read in data packets from the second input interface and forward the read in data packets from the second input interface to the downstream processing device, wherein, in the second operating mode, the synchronization device is configured to forward the read in data packets from the second input interface with a timing that corresponds to a timing with which the read in data packets from the second interface are provided at the second input interface, and
in a third operating mode, to read in the data packets from the second input interface and forward the read in data packets from the second input interface to the downstream processing device, wherein, in the third operating mode, synchronization device is configured to forward the read in data packets from the second input interface with a timing that corresponds to a timing with which further data packets are provided by the environment sensor at the first input interface;
wherein the at least one environment sensor is configured to provide the sensor data in the form of data packets at the first input interface.

17. The sensor system according to claim 6, futher comprising:
a memory device configured to store sensor data in a form of data packets and to provide the stored sensor data at the second input interface1.

18. The sensor system according to claim 6, wherein the stored sensor data include simulated sensor data and/or previously captured sensor data from the at least one environment sensor.

19. A method for testing a sensor system, comprising the following steps:
in a first operating mode, receiving data packets from an environment sensor and forwarding the receive data packets from the enviroment sensor for further processing, wherein, in the first operating mode, the data packets are accepted and processed with a timing that corresponds to a timing with which the data packets are provided by the environment sensor;
in a second operating mode, receiving previously stored data packets and forwards the received previously stored data packets for further processing, wherein, in the second operating mode, the data packets are received and processed with a timing that corresponds to a timing with which the previously stored data packets are provided; and
in a third operating mode, receiving the previously stored data packets and forwarding the previously stored data packets for further processing, wherein, in the third operating mode, the previously stored data packets are received and processed with a timing that corresponds to a timing with which further data packets are provided by the environment sensor.

20. The method according to claim 19, further comprising recording and storing data from at least one environment sensor.
